(19) United States
(12) Patent Application Publication
(10) Pub. No.: US 2007/0231237 A1
(43) Pub. Date: Oct. 4, 2007

(54) Process for the preparation of silicon carbide from spent pot liners generated from aluminum smelter plants

(75) Inventor: Bimanranjan Mazumder, Bhubaneswar (IN)

Correspondence Address: LADAS & PARRY, 26 WEST 61ST STREET, NEW YORK, NY, 10023, US

(73) Assignee: COUNCIL OF SCIENTIFIC AND INDUSTRIAL RESEARCH

(21) Appl. No.: 11/499,398

(22) Filed: Aug. 4, 2006

(30) Foreign Application Priority Data
Mar. 28, 2006 (IN) 861/DEL/2006

(51) Int. Cl. C01B 31/36

(52) U.S. Cl. 423/345

(57) ABSTRACT

The present invention provides a process for the preparation of silicon carbide from spent pot liners generated from aluminum smelter plants. The present invention involves the use of spent pot liner (in short hereafter termed as SPL) by means of comminution of SPL by a chemical reaction followed by mixing it with appropriate proportion of commercially available quartz powder (high purity silica powder having particle size of −100 BS mesh) and further followed by heating it in an argon plasma furnace for about 3 minutes. The product of this process is a granular powder of silicon-carbide as determined by XRD analysis. The yield of the carbon powder obtained is in the range of 30-35% and the percentage conversion to silicon carbide obtained is in the range of 70 to 85%.

### FIELD OF THE INVENTION

The present invention relates to a process for the preparation of silicon carbide from spent pot liners generated from aluminum smelter plants.

Carbon pot liners are used as cathode in electrolysis cell for extracting aluminum by smelter plants and at the end of their service life these carbon cathode blocks are rejected and new carbon electrodes are installed. These used and rejected carbon liners are called Spent Pot Liners and they are highly contaminated by fluoride, cyanide, alkali etc. Being contaminated with highly toxic elements, their disposal possess a great problem for all aluminum smelter plants. Accordingly, the present invention provides a means for utilization of these pot liners and convert them to an useful industrial product, namely silicon-carbide.

### BACKGROUND OF THE INVENTION

Attempts have been made earlier to remove contaminants from spent pot liners. Reference may be made to (U.S. Pat. No. 6,498,282, granted 24 Dec., 2002) wherein oxides of iron was added to spent pot liner and melted in a high temperature furnace in order to remove the contaminants in the form of slag. In yet another prior art (U.S. Pat. No. 5,245,116, granted Sep. 14,m 1993) lime was added to crushed spent pot liner in an aqueous medium and the fluoride precipitated as calcium fluoride by heating to 140° C. in presence of clay to fix soda as well. In yet another prior art (U.S. Pat. No. 435,279, granted Sep. 24, 1996) Henning & Mollgard disclosed a process whereby aluminum and fluoride in spent pot liner was recovered as AlF₂OH by leaching with dilute sulfuric acid and adjusting fluorine to aluminum ratio between 1.8-2.2. In yet another similar prior art (U.S. Pat. No. 4,900,535, U.K. Patent Applcn 056422A and U.S. Pat. No. 2,858,198, granted in 1986), the spent pot liner after crushing was treated with concentrated sulfuric acid and heated to elevated temperature (1200° C.) whereby fluoride values are reacted to and withdrawn as hydrofluoric acid. These pyrohydrolysis processes exhibits inconvenience like corrosion to equipments etc and thus have not been commercialized yet. In yet another prior art (U.S. Pat. No. 2,186,433) the spent pot liner was treated with a mixture of hydrochloric acid and sulfuric acid and the fluoride value was precipitated as cryolite. The process has inherent drawback of contaminating the process liquor and precipitated end product due to dissolution of iron and silica and coprecipitation of iron hydroxide. In yet another prior art (U.S. Pat. No. 4,889,695 and European Patent Applcn No. 117616) spent pot liners were treated with alkali like sodium-hydroxide. Although fluoride value was recovered by precipitating end product, alkali route takes a long time to reach completion, results in foam formation and requires rather complicated careful controlled conditions. Further alkali is not removed completely by such treatment. In yet another prior art (U.S. Pat. No. 4,508,689) removal of alkali in above process attempted by incomplete neutralization method to make precipitated product (aluminum fluoride) sodium free. But incomplete neutralization to pH below 5 results in significant loss of fluorine value.

Further attempts have been made to decontaminate and produce silicon-carbide from spent pot liner in a closed electrothermic smelting furnace. Reference may be made to a prior art disclosed by Lindkvist et al (U.S. Pat. No. 5,286,274) crushed untreated spent pot liner was mixed with silica and melted at a temperature of 1300 to 1750° C. The spent pot liner was oxidized in smelting furnace after incorporating oxidizing agents like calcium oxide to form calcium-fluoride, calcium aluminate or calcium aluminate silicate slag. However such processes are simply not well suited to remove all impurities contained in the waste material (spent pot liner). In a similar prior art (U.S. Pat. No. 6,471,931 granted Oct. 29, 2002) Brosnan disclosed a process where the spent pot liner first crushed to less than 1 mm size, then mixed with appropriate amount of silica and then heated in a electric resistance furnace under close control of reducing atmosphere to a temperature between 1800 to 2200° C. Silica for such purpose was derived from fumed silica, fly ash, clay or metal silicones. The product was then separated gravimetrically. In such process starting material being untreated highly contaminated carbon source, the final product purity is unknown. Further emanation of hydrofluoric acid may corrode the reacting furnace and its accessories. Energy consumed both in pulverization of spent pot liner and prolonged heating in resistance furnace is also high. Other similar prior arts for making silicon carbide from carbon includes U.S. Pat. Nos. 492,767, 3,306,705, 4,659,022, and 5,190,737.

### OBJECTS OF THE INVENTION

The main objective of the present invention is to provides a process for making silicon carbide from spent pot liners generated by aluminum smelter plants which obviates the drawbacks of the hitherto known prior art as detailed above.

Yet another objective of this invention is to provide finer particles of carbon particles from the spent pot liner by chemical reaction for preferred and complete reaction between silica and the recovered carbon from spent pot liner in the high temperature reaction step.

Yet another objective of this process is to remove the corrosive element like fluoride in the spent liner before reacting it at high temperature furnace in order to avoid corrosion to the furnace lining and its accessory elements.

Still another objective of this invention has been to heat the carbon powder recovered from spent pot liner along with silica in a special furnace (e.g. plasma furnace) so that the reaction time can be reduced considerable & thereby enhance its rate of production in commercial scale.

The novelty of the process lies in inventing a unique acid treatment process by which all contaminants in the spent pot liners are removed before the reaction of recovered carbon powder with stoichiometric proportion of silica in a furnace to produce silicon-carbide. Further novelty of the process lies in the reaction of the said recovered carbon powder from SPL along with commercially available silica powder in an argon plasma furnace thereby reducing formation time of the end product silicon-carbide to few minutes only and provides a tool for handling and processing of large volume of raw material in shortest possible time to manufacture silicon-carbide. SPL processed by the said means to free all contaminants, generates a carbon powder clean enough and do not produce toxic fumes of the contaminants generally occurring in SPL and thus furnace linings, are not affected.

Accordingly the present invention provides a process for the preparation of silicon-carbide from spent pot liners generated from aluminum smelter plants, the said process comprising the steps of:
a. crushing the spent pot liner to size of half-inch to dust, followed by treating it with concentrated chromic acid, for a period of 15-25 minutes;
b. washing the above said reaction product with distilled water until the filtrate is neutralized, followed by drying at a temperature of about 100° C. and subjecting it to a thermal shock, at a temperature of about 900° C., for a period of 1-2 minutes to obtain the free flowing carbon powder,
c. mixing the above said free flowing carbon powder with −100 BS mesh silica powder in a molar ratio of about 1:3 to 1:5 and reacting the resultant mixture in an argon plasma furnance, for a period of about 2 minutes to obtain the desired silicon-carbide powder.

In an embodiment of the present invention the spent pot liner obtained from aluminium smelter plant has fluorides, alkalies and free aluminium in the range of 8-9%, 7-8% and 2-3%, respectively.

In yet another embodiment the free flowing carbon powder obtained in step (b) has the average particle size of 20 micrometer.

In yet another embodiment the yield of the carbon powder obtained in step (b) is in the range of 30-35%.

In still another embodiment the percentage conversion to silicon carbide obtained is in the range of 70 to 85%.

### DETAIL DESCRIPTION OF THE INVENTION

The present invention is describes a process for use of spent pot liner (in short hereafter termed as SPL) by means of comminution of SPL by a chemical reaction followed by mixing it with appropriate proportion of commercially available quartz powder (high purity silica powder having particle size of −100 BS mesh) and further followed by heating it in an argon plasma furnace for about 3 minutes. The product of this process is a granular powder of silicon-carbide as determined by XRD analysis. Silicon carbide is a hard refractory material having high thermal conductivity value. It possess high strength even at elevated temperature and a useful commodity in commerce with many useful applications like abrasive material, high temperature resistant refractory block, structural ceramics, material for making hard dies, crucibles in metallurgical industries etc. Other uses are expected along the lines of commercially manufactured silicon carbide.

In the present invention the spent pot liner collected from aluminum smelter plants are first broken down by jaw crusher/hammer mill from half-inch to dust size with half-inch particles constituting 70% of the bulk. This broken pieces of spent pot liners placed in a glass vessel and then slowly freshly prepared chromic acid was added with constant stirring. The reaction is exothermic and addition rate of the acid needs to be controlled to keep the reaction temperature within about 90° C. Total amount of acid needs to be added just to make the mixture a thick paste. The mixture then allowed to stand about 15-25 minutes. End of reaction is indicated by no more emanation of gas bubble from the mixture. The mixture is allowed to cool down to about room temperature and then equal volume of distilled water added with stirring followed by filtration through a regular filter paper placed in a funnel. The residue is repeatedly washed with distilled water until the filtrate is free of acid. The fluoride escapes as hydrofluoric acid and can be trapped by bubbling the emanated gas through a dilute solution of sodium hydroxide. The filtrate containing chromium (III) ion can be precipitated by addition of sodium hydroxide solution. The washed carbon powder is practically free from all contaminants as can be seen in Examples 1 and 2 below. The carbon powder thus derived from SPL is then dried in an oven at around 100° C. for two hours and then subjected to a thermal shock in a preheated furnace (preheated to about 900° C. for about a minute. This results in a free flowing carbon powder having average particle size of 20 micron as determined by Malvern Particle Size Analyzer.

The non-obvious inventive steps by this invention comprises:
a) Breaking the spent pot liners to a size range of half inch to dust (half inch fraction constituting at least 70% of the bulk).
b) Reacting the said crushed spent pot liner with concentrated chromic acid with constant stirring maintaining reaction temperature to about 90° C.
c) Washing the reacted product with distill water until neutral and drying the recovered carbon powder in an oven at 100° C. for about 1 hour.
d) Subjecting the said recovered carbon powder to thermal shock for about a minute in a preheated (preheated to about 900° C.) furnace to obtain a free flowing carbon powder.
e) Mixing the said carbon powder with stoichiometric proportion of commercially available silica powder and reacting in an argon plasma furnace for about 3 minutes to obtain silicon-carbide in granular form.

The present invention provides a process for making silicon carbide from spent pot liners generated by aluminum smelter plants which comprises process steps involving crushing the spent pot liner to a size range of half inch to dust (half inch fraction constituting about 70% of the mass), reacting the powdered spent pot liner with concentrated chromic acid for about 15 minutes, washing the reacted mass with distill water until the filtrate is neutral, drying the recovered carbon powder in an oven at about 100° C. for about an hour and thereafter subjecting the said carbon powder to thermal shock in a 900° C. preheated furnace for about a minute to transform it to a free flowing carbon powder, thereafter mixing the said carbon powder with about a stoichiometric proportion of commercially available silica powder (−200 BS mesh) and reacting the mixture in an argon plasma furnace for about 3 minutes to obtain silicon-carbide in granular form.

One of the features of the present invention is that the spent pot liner was crushed to a size range of half inch to dust with half inch fraction constituting about 70% of the mass and reacted with concentrated chromic acid for about 15-25 minutes with constant stirring in order to maintain reaction temperature within 90° C. The reacted mass was then washed with distill water until the filtrate was neutral. The recovered carbon powder from said filtration step was dried in an oven for about an hour at about 100° C.

Another feature of the present invention the said recovered carbon powder from spent pot liner treatment was subjected to a thermal shock at about 900° C. for about a minute in a preheated furnace.

Yet another feature of the invention, the said carbon powder derived from SPL was mixed (3:1 molar ratio) silica powder (commercially available quartz powder having particle sizes less than 100 BS mesh) and reacted in the high temperature of an argon plasma furnace. The powder was carried by argon gas into the plasma furnace and starts reacting as soon as it enters the high temperature zone of the furnace. Total reaction time was about 3 minutes. The product silicon-carbide was collected in a graphite crucible placed at the bottom of the hearth of the plasma furnace. Supply of argon gas into the furnace was continued for about another 1 minutes after the reaction was over. The collected sample of silicon-carbide was analyzed by XRD apparatus and found to contain substantial amount of silicon-carbide in the powder product and the said carbon powder derived from SPL was mixed in molar ratio of 4:1 (stoichiometric ratio being 3:1) with silica powder (commercial grade quartz powder having particle size −100 BS mesh) and the experiment repeated exactly same as above. The granular product indicate substantial amount of silicon carbide in the product by XRD analysis.

One of the feature of the present invention is also that, the said carbon powder derived from SPL was mixed in molar ratio 5:1 with silica powder (commercial grade quartz powder having particle size −100 BS mesh) and the experiment repeated in the argon plasma furnace exactly in the same manner. XRD analysis of the granular product indicates presence of substantial amount of silicon-carbide.

The following examples are given by way of illustration and therefore should not be constructed to limit scope of the present invention:

### EXAMPLE 1

Results showing chromic acid treatment of two different size SPL

| | | Before Treatment | | | After Treatment | | |
|---|---|---|---|---|---|---|---|
| Expt | | | | Free | | | Free |
| No | SPL sieve | Fluoride | Alkali | Al | Fluoride | Alkali | Al |
| 1 | ½ inch | 8% | 7% | 2% | 0.0132% | 0.19% | Nil |
| | to dust | | | | | | |
| 2 | −100 BS | 8% | 7% | 2% | 0.0039% | 0.10% | Nil |

### EXAMPLE 2

Characteristics of the carbon powder derived from SPL

| | | Average Particle | | |
|---|---|---|---|---|
| Expt No. | SPL Sieve size | Size | Yield (%) | Ash (%) |
| 1 | ½ inch to dust | 20 micro-meter | 30 | 10 |
| 2 | −100 BS | 20 micro-meter | 30 | 10 |

### EXAMPLE 3

| | Molar ratio | | |
|---|---|---|---|
| Expt No | of Silica:Carbon* | Type of plasma used | % Conversion to SiC |
| 1 | 1:3 | Argon | 70% |
| 2 | 1:4 | Argon | 85% |
| 3 | 1:5 | Argon | 85% |

Above results indicate decontaminated spent pot liners by the said process can be substantially converted into silicon carbide using argon plasma furnace by the said process steps. Further, the treatment time being small it will be easier to process large volume of said raw materials in an actual commercial scale unit.

### ADVANTAGES OF THE INVENTION ARE

1. The process provides a means for utilizing waste material such as spent pot liners of aluminum smelter plants.

2. The said spent pot liners need not be powdered to very fine size and thus saving both energy and time in processing the starting material.

3. Since the spent pot liner is cleaned of its contaminants before reacting in high temperature, the furnace and its ancillaries are not corroded by the said process.

4. The process is simple and can be carried out in shortest possible time.

5. The process does not require stringent control of reaction parameters as required in solution precipitation techniques as mentioned in prior art for deriving the final product.

6. The process is easy to scale up.

7. The process generates a product which has high commercial value.

We claim:

1. A process for the preparation of silicon-carbide from spent pot liners generated from aluminum smelter plants, the said process comprising the steps of:
a. crushing the spent pot liner to size of half-inch to dust, followed by treating it with concentrated chromic acid, for a period of 15-25 minutes,
b. washing the above said reaction product with distilled water until the filtrate is neutralized, followed by drying at a temperature of about 100° C. and subjecting it to a thermal shock, at a temperature of about 900° C., for a period of 1-2 minutes to obtain the free flowing carbon powder,
c. mixing the above said free flowing carbon powder with −100 BS mesh silica powder in a molar ratio of about 1:3 to 1:5 and reacting the resultant mixture in an argon plasma furnance, for a period of about 2 minutes to obtain the desired silicon-carbide powder.

2. A process according to claim 1, wherein the spent pot liner obtained from aluminium smelter plant has fluorides, alkalies and free aluminium in the range of 8-9%, 7-8% and 2-3%, respectively.

3. A process according to claim 1, wherein the free flowing carbon powder obtained in step (b) has the average particle size of 20 micrometer.

4. A process according to claim 1, wherein the yield of the carbon powder obtained in step (b) is in the range of 30-35%.

5. A process according to claim 1, wherein the percentage conversion to silicon carbide obtained is in the range of 70 to 85%.
